(19) United States
(12) Patent Application Publication
(10) Pub. No.: US 2022/0032783 A1
(43) Pub. Date: Feb. 3, 2022

(54) Stabilisation and levitation mechanism for a dedicated vehicle, taking into account the interoperability with existing transport systems in the vicinity of switches and routes of conventional vehicles and how the vehicle is stabilised in the stabilisation and levitation mechanism

(71) Applicant: HYPER POLAND SPOLKA Z OGRANICZONA ODPOWIEDZIALNOSCIA, Warszawa (PL)

(72) Inventors: Grzegorz SWIATEK, Warszawa (PL); Pawel RADZISZEWSKI, Warszawa (PL); Przemyslaw PACZEK, Warszawa (PL); Tomasz KUBLIN, Warszawa (PL); Lukasz ORDYSZEWSKI, Ilowoosada (PL)

(73) Assignee: HYPER POLAND SPOLKA Z OGRANICZONA ODPOWIEDZIALNOSCIA, Warszawa (PL)

(21) Appl. No.: 17/415,470

(22) PCT Filed: Dec. 18, 2019
(86) PCT No.: PCT/IB2019/060986

§ 371 Date: Jun. 17, 2021

(30) Foreign Application Priority Data
Dec. 18, 2018 (PL) PL428243

(51) Int. Cl. B60L 13/08; B61B 13/08; B61B 15/00; E01B 25/30

(52) U.S. Cl. CPC B60L 13/08; E01B 25/30; B61B 15/00; B61B 13/08

(57) ABSTRACT

The subject of the invention is stabilisation and levitation mechanism for a dedicated vehicle, taking into account interoperability with existing transport systems in the vicinity of switches and routes of conventional vehicles, containing the ground, on which the rails are fixed, wherein on both sides of the rail system, preferably on the track bed, at least along a fragment of the track used by conventional vehicles there are guiding walls, mounted on movable supporting elements.

The subject of the invention is a stabilisation and levitation mechanism for a dedicated vehicle, taking into account the interoperability with existing transport systems in the vicinity of switches and communication routes of conventional vehicles and the method of vehicle stabilisation in the stabilisation and levitation mechanism ensuring lateral stabilisation and change of the driving track of vehicles dedicated to the magnetic railway system. The invention allows for interoperability with existing transport systems, in particular with conventional wheel-rail rail.

Conventional rail should be broadly understood as any rail vehicles, such as rail and, inter alia, tram and metro vehicles, moving on a rail-faced surface using the rolling wheels in the running gear of the vehicle. The solution is designed to handle vehicles dedicated to levitation as well as those moving in physical contact with the ground.

A vehicle dedicated to the magnetic railway should be understood as any moving object capable of using this solution.

The way of changing direction of a magnetic railway vehicle, describing the operation of guiding walls used to stabilise and change the track during vehicle movement is known from document US20070044676A1. However, it does not describe the application for the purpose of integrating this system with other transport systems, in particular conventional railway.

Document DE4141426A1 shows how to change the direction of the vehicle by means of the system's sliding guides to select the driving path. Its use is, however, limited to suspended vehicles, and does not include ground or levitating vehicles, and for two-way, two-track traffic, whereas in the proposed solution it can be used for one-way traffic. Nor does it describe the application for the purpose of integrating different transport systems, in particular magnetic railway. In addition, the proposed system can be used for any radii and high speeds, even over 100 km/h, while the system in that document operates at specific radii and speeds up to 60 km/h.

In order to be able to make full use of the existing transport corridors it is necessary to share space within different transport systems. A common solution is a high speed rail route designed and built along an existing motorway. The subject of the invention allows sharing the same infrastructure within different transport systems, in particular with conventional wheel-rail railways.

A conventional vehicle shall be understood to mean vehicles intended to run on systems with which this invention is integrated enabling the running of dedicated vehicles. A conventional vehicle means in particular: a conventional wheel-rail type running on a track system or storage vehicles running on a designated track.

According to the invention, the stabilisation and levitation mechanism for a dedicated vehicle, taking into account interoperability with existing transport systems in the vicinity of switches and routes of conventional vehicles, contains at least the ground (2.b) on which preferably the rails are fixed (2.a), and on both sides of the track bed of the rail system (2), placed on the ground (2.b), preferably the track bed (2.a), there are guiding walls (3.c), mounted on movable supporting elements (3.b) at least along a section of the running track of the conventional vehicle.

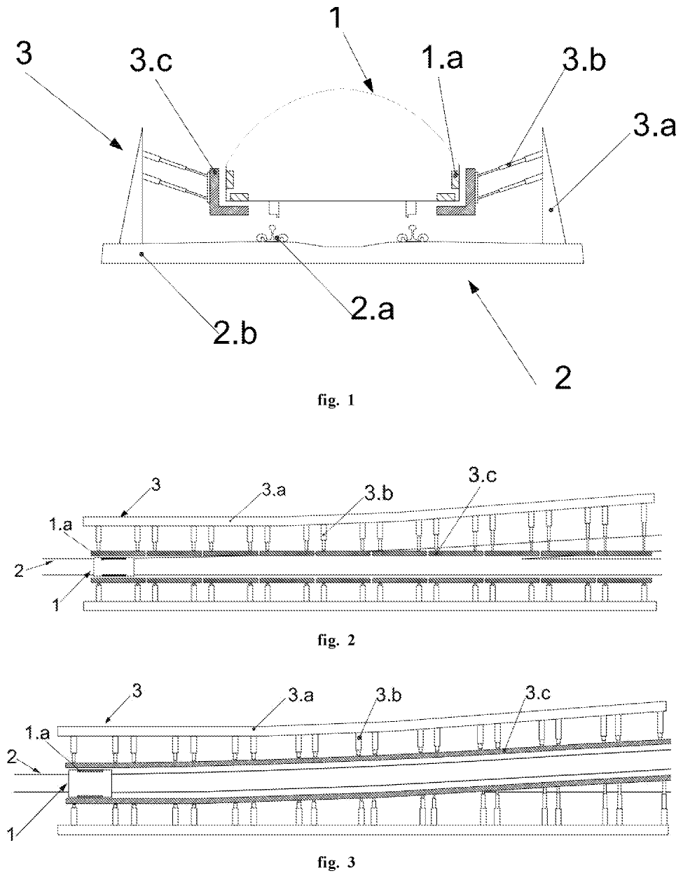

Guiding wall should be understood as an active or passive element to stabilise the dedicated vehicle and/or to select the driving path. It is advantageous when the guiding walls are in particular: an electromagnet system cooperating with permanent magnets installed on a dedicated vehicle, or an aluminium plate or sections, preferably bevels or C-sections, cooperating in contact with an additional vehicle arm. It is advantageous when the guiding walls are shaped so as to allow levitation of the vehicle (element 3.c in FIG. 1).

Guiding walls, depending on the execution example, can be made in segments, as shown in FIG. 2 or as a monolithic section, as presented in FIG. 3. Both solutions allow the curvature of the arch to be reproduced. They can be made as active or passive. Active walls are equipped with electromagnets (3.d in FIG. 10) cooperating with a magnetic field originating from a vehicle (1.a), equipped with para- or diamagnetic materials (e.g. aluminium or copper) and attracting it. Passive walls can also work with the vehicle through electromagnetic or frictional forces. Passive electromagnetic walls are made of para- or diamagnetic material (e.g. aluminium or copper) mounted on ferromagnetic material. Such a system, while the dedicated vehicle is moving, will push it away from the guiding walls. Passive friction walls are made of durable material resistant to abrasion and deformation.

It is advantageous if the vehicle is equipped with an additional stabilising arm, by contacting the guiding wall, to keep the vehicle on the right track or to select the direction at the switch.

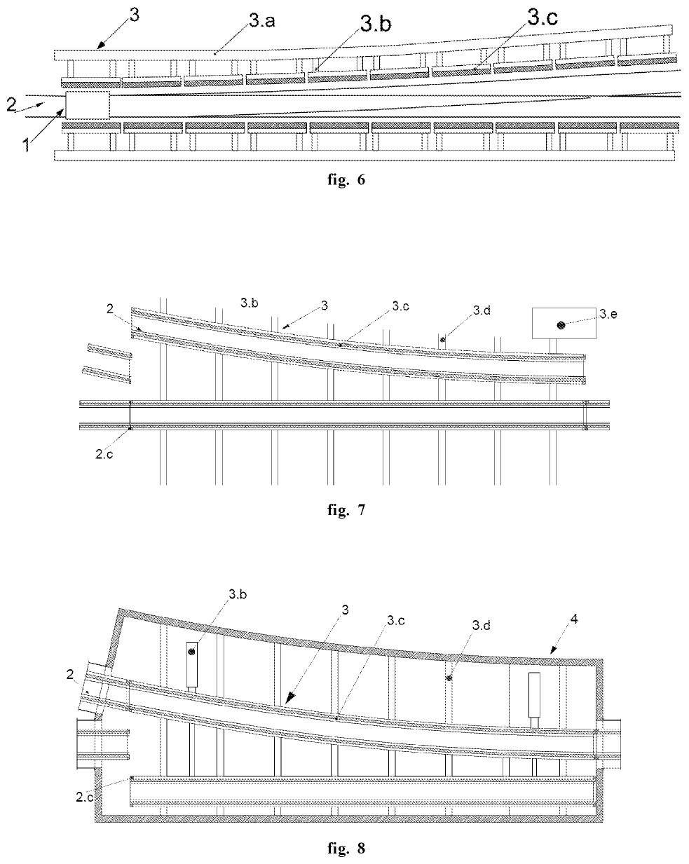

Each guiding wall can be in two positions: the main position and the resting position. The resting position means the position of the guiding walls outside the contour of the structure gauge (FIG. 6) allowing conventional rail vehicles to run safely on the track (2.a) of the railway system (2).

The main position means the positioning of the guiding walls within the contour of the structure gauge and determining the running track of the dedicated vehicles (FIG. 2 and FIG. 3). In another example, each guiding wall can also be placed on integrated guides.

The movable cantilever elements are chosen preferably from among hydraulic and/or pneumatic and/or electric cylinders, or are integrated guides.

Integrated guides are to be understood in particular as linear guides, guide rails or rack- and-pinion mechanisms to which existing transport systems can be fitted at the same time, in particular the conventional railway systems and the stabilisation and levitation mechanism positioned outside the gauge of a given transport system. They allow these systems to be moved in order to choose the right driving path and allow both dedicated and conventional vehicles to move on them.

It is advantageous for the whole mechanism to be placed in a tube (4), in which a vacuum is created, while maintaining the tightness and functionality of the whole system.

According to the invention, the method of stabilising the vehicle in the stabilisation and levitation mechanism consists in the fact that during the passage of a conventional vehicle the guiding walls are placed in the resting position and, before the passage of a dedicated vehicle, the railway infrastructure is adjusted by means of the invention mechanism preferably immediately before such passage, so that the guiding walls are forced by means of actuators to move closer to the axis of the running track, i.e. to the main position, and after the passage of a dedicated vehicle, the guiding walls are moved back to the resting position by means of actuators, again allowing conventional vehicles to pass.

The driving path of dedicated vehicles is directed by frictional forces which act on rotating stabilising elements or sliding bearings mounted in the dedicated vehicle.

End-positioning and blocking of the movement of the guiding walls for the passage of the vehicle is effected by means of mechanical stops or electromagnets (2.c), located at the extremes of the switch sections and at the extremes of the fixed track, which operate in the last phase of the movement, setting the mechanism in contact with the fixed part of the infrastructure.

The stabilisation and levitation mechanism for a dedicated vehicle, taking into account interoperability with the existing transport systems in the vicinity of switches and routes of conventional vehicles, including the ground on which the tracks are fixed, is characterised by the fact that on both sides of the railway system, preferably on the track bed, at least along a fragment of the track used by conventional vehicles there are guiding walls, mounted on movable supporting elements.

The guiding walls are mounted on movable supporting elements in the form of actuators enabling their position to be changed, the actuators being attached to energy-absorbing barriers located along at least a part of the railway system—track bed, placed on the ground or directly in the ground.

The guiding walls are either shaped like an angle that embraces the dedicated vehicle on its underside and side, or they are shaped like a plate that embraces the vehicle on its underside or side, while the source of the magnetic field is built into the dedicated vehicle and is positioned so that it corresponds to the position of the guiding walls.

In the dedicated vehicle, along at least a fragment of its lateral surfaces, rotary stabilising elements or sliding bearings cooperating with at least one guiding wall are mounted.

In the dedicated vehicle, dia- or paramagnetic materials affected by electromagnetic forces are preferably installed along the side and/or underside of the dedicated vehicle.

The guiding walls are equipped with diamagnetic or paramagnetic materials, which are affected by electromagnetic forces.

The mechanism is preferably equipped with an emergency system based on a manual method and a pyrotechnic actuator.

The guiding walls are preferably mounted on side actuators, slide out from below or slide on integrated guides.

The actuators are preferably hydraulic or pneumatic or electric.

The guiding walls in the form of a plate extending from below are mounted parallel to the dedicated vehicle and act as a longitudinal guiding guide along which the dedicated vehicle is directed.

The guiding walls are permanently mounted on integrated guides placed transversely in the ground in the form of a guide bar, linear guide or rack-and-pinion mechanism, together with the track of a conventional vehicle, preferably equipped with rails or not.

The mechanism is preferably used for any traffic speed and any turning radius of dedicated and conventional vehicles.

Another subject of the invention is the method of stabilising the vehicle in the stabilisation and levitation mechanism, characterised by the fact that during the passage of a conventional vehicle the guiding walls are placed in the resting position, and before the passage of a dedicated vehicle by means of the mechanism according to the invention the railway infrastructure is adjusted so that by means of actuators the guiding walls are forced to move closer to the axis of the driving path, i.e. to the main position, and after the passage of the dedicated vehicle the guiding walls are moved back to the resting position by means of actuators allowing the conventional vehicles to pass again.

The track of dedicated vehicles is preferably directed by frictional forces which act on rotating stabilising elements or sliding bearings mounted in the dedicated vehicle.

The direction of the movement of a dedicated vehicle is preferably guided by the electromagnetic forces created by the interaction of magnetic fields from the dedicated vehicle and the guiding walls.

Preferably, the positioning of the mechanism according to the invention in the switch area, in order to connect the track for travelling to straight or turning, is carried out by means of mechanical stops or electromagnets that set and lock the mechanism in its final position.

For the passage of the vehicle, the movement of the guiding walls is preferably blocked in their final positions by means of mechanical stops or electromagnets, located at the extremes of the switch sections and at the extremes of the fixed track, which operate in the last phase of the movement, setting the mechanism in contact with the fixed part of the infrastructure.

The mechanism according to the invention allows to stabilise and change the driving path of dedicated vehicles without affecting the structure gauge of a conventional rail vehicle. The subject of the invention is particularly applicable to switching infrastructure. In the railway industry, apart from the tracks, switches are equipped with additional infrastructure supporting them, which is located approximately 0.5 m from the track (2.a) and at its level. Examples of such additional infrastructure include: switch drives or heating transformers. The subject of the invention allows to place the guiding wall in the structure gauge area non-invasively without affecting the additional infrastructure. Using the solution presented in the invention, it is possible to use both means of transport, i.e. a conventional rail vehicle and a dedicated vehicle on a route, within sidings, stations, etc.

The mechanical solution for changing the driving path of a dedicated vehicle, included in the description of the invention, ensures the interoperability of the system for all known track gauges of rail vehicles, both on the ballasted and non-ballasted track.

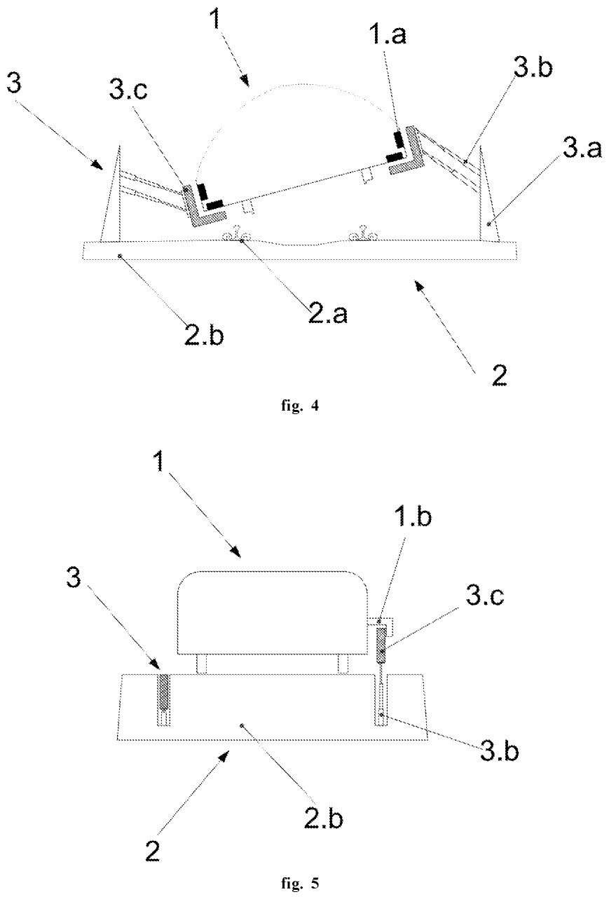

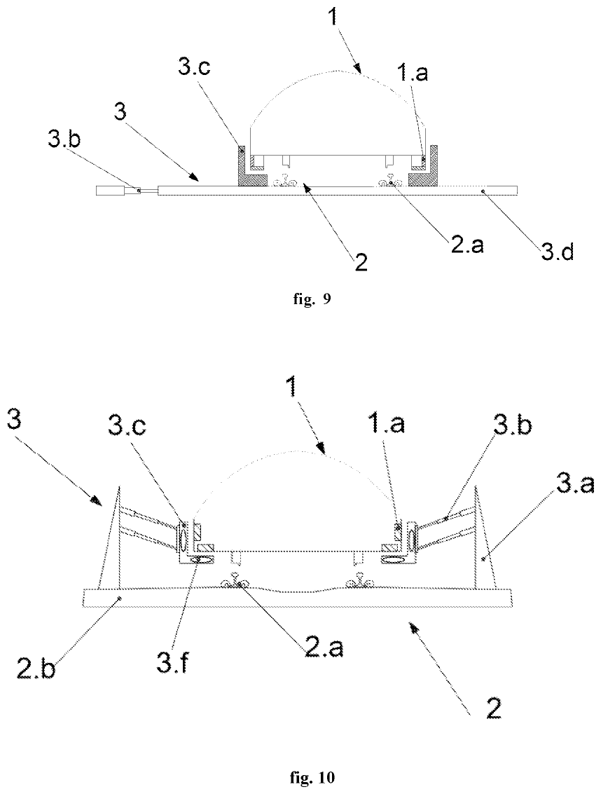

The subject of the invention is depicted in the embodiment and shown in the drawing on which FIG. 1 presents a cross-section of the mobile stabilisation and levitation mechanism and railway infrastructure, FIG. 2 shows a view of the guiding walls made in segments, FIG. 3 shows a view of the guiding walls made monolithically, FIG. 4 presents a variant of the guiding walls 3c, which allow the vehicle to be tilted at high speed, FIG. 5 shows a cross-section of an alternative mechanism design consisting of guiding walls extending according to the direction in which the vehicle is to move, FIG. 6 shows the position of the guiding walls outside the outline of the structure gauge in the resting position, FIG. 7 shows the stabilisation and levitation mechanism and railway infrastructure mounted on integrated guides along which the whole mechanism can move, FIG. 8 presents the same mechanism placed inside a tube, FIG. 9 shows a section of this mechanism on integrated guides, and FIG. 10 shows the mechanism fitted with active elements.

The movable stabilisation and levitation mechanism (3) and the railway infrastructure shown in FIG. 1 consists of guiding walls (3.c), mounted on actuators (3.b) enabling changing the position of the guiding walls. The actuators are fixed to an energy-absorbent barrier (3.a), which in turn is fixed to the ground (2.b) being part of the railway infrastructure (2). The system allows the guiding walls to be moved close to the dedicated vehicle (1).

The invention functions as follows: the guiding walls are in the resting position when a conventional vehicle passes. Before a dedicated vehicle passes through, the moving mechanism must adjust the infrastructure. Movement of the actuators causes the guiding walls to move closer to the axis of the driving path, i.e. to the main position. This allows the dedicated vehicle to pass freely and safely. The actuators then move the guiding walls back to their resting position again allowing conventional vehicles to pass.

The mechanism according to the invention directs the movement of dedicated vehicles by means of friction forces which act on rotating stabilising elements or sliding bearings mounted in the dedicated vehicle.

The alternative design of the mechanism shown in FIG. 5 consists of guiding walls which extend according to the direction in which the vehicle is to move. There are two guiding walls on one side, one for non-directional driving and the other for changing direction. The guiding walls are mounted on actuators that allow them to be extended. The actuators are fixed to the ground. The system allows the guiding walls to be moved close to the dedicated vehicle, ensuring its stability.

Another version of the mechanism presented in FIG. 7 allows the guiding walls, levitation mechanism and railway infrastructure to be mounted on transverse integrated guides (3.d). This allows the track (2) to be moved along the guides by means of actuators (3.b) or motor (3.e) and its shape to be adjusted to the version of the switch needed at a given time. Thanks to an appropriate arrangement of guiding and levitation walls (3.c), the gauge requirements, in particular structure gauge, will be maintained and it will be possible to drive both conventional and dedicated vehicles. End-positioning and blocking of traffic for the passage of the vehicle may be effected by means of mechanical stops or electromagnets (2.c), located at the extremes of the switch section and at the extremes of the fixed track, which would function in the last phase of the movement, setting the mechanism in contact with the fixed part of the infrastructure. In addition, the entire mechanism can be closed by means of a tube (4), in which vacuum can prevail, while maintaining the tightness and functionality of the entire system.

Guiding walls can be made in segments, as shown in FIG. 2 or as a monolithic section, as presented in FIG. 3. Both solutions allow the curvature of the arch to be reproduced. They can be made as active or passive. Active walls will be equipped with electromagnets (3.d in FIG. 10) cooperating with a magnetic field originating from vehicle 1.a, equipped with para- or diamagnetic materials (e.g. aluminium or copper) and attracting it. Passive walls can also work with the vehicle through electromagnetic or frictional forces. Passive electromagnetic walls will be made of para- or diamagnetic material (e.g. aluminium or copper) mounted on a ferromagnetic material. Such a system, while the dedicated vehicle is moving, will push it away from the guiding walls. Passive friction walls will be made of durable material resistant to abrasion and deformation. When moving a dedicated vehicle equipped with a stabilising arm, through contact with a guiding wall, it maintains the correct driving path or selects the direction at the switch.

An important feature of the guiding walls 3.c is the possibility to make them in a form allowing for magnetic levitation of dedicated vehicles. By means of their appropriate geometric shape (e.g. by making them in the form of an angle), the vehicle is able to move on the designated track using the horizontal part of the guiding wall as the ground, as shown in FIG. 1. This feature also allows to tilt the driving path, so that the dedicated vehicle can pass a switch or curve at a higher speed as shown in FIG. 4. A dedicated vehicle can move on the ground as a result of electromagnetic forces (e.g. moving on a magnetic cushion).

The devices holding the guiding walls in place must withstand a force applied to them at least equal to the centrifugal force applied to the vehicle at a curve or a switch. If the levitation mechanism is also used, these devices must also withstand the weight of a passing dedicated vehicle. If integrated guides are used, it must be possible to move a sufficiently long section of the combined track for dedicated and conventional vehicles along the guides. Therefore, actuators, particularly hydraulic, pneumatic or electric ones, must have a high resistance to sudden changes in pressure, so that the whole system is rigid and stabilises passing vehicles and has sufficient force to move the relevant systems. At the same time, the fast action of the actuators, i.e. a change in the state of the mechanism, will ensure smooth operation of the transport system.

Emergency control is based, for example, on a manual method and a pyrotechnic actuator similar to that proposed in document PL 225 323 B1. The manual method consists in shifting the stabilisation guiding wall from the resting position to the main position or vice versa by means of a mechanical connection coupled with a handle used to change the position of the object by means of muscle force. For the version of the mechanism proposed in FIG. 7 the track and the stabilisation and levitation guiding walls (if applicable) are adjusted simultaneously.

Emergency control based on a pyrotechnic actuator is triggered remotely or directly from a location next to the switch. It complements the manual control when it is not possible to reach the switch site in less than the time necessary to move the guiding wall before the arrival of the vehicle in motion on a given line or it is impossible to move the guiding wall by means of muscle force.

The essence of the invention is a solution enabling movement of track elements ensuring lateral stability and changing the direction of the dedicated vehicle. It also provides integration with existing transport systems. It then allows the elements (3.b and 3.c in FIG. 1) of the track to be within the gauge area in force, e.g. the structure gauge, understood as the main state, when a dedicated vehicle passes, and to be outside the structure gauge, understood as the resting state, when a conventional vehicle passes. Guiding walls are moved by remote or autonomous actuators with emergency control. An alternative version of the solution allows the use of integrated guides and simultaneous movement of all track elements, both for dedicated and conventional vehicles to change track, ensuring the interoperability of systems by means of actuators or a rack-and-pinion mechanism and positioning them by means of electromagnets.

1. Stabilisation and levitation mechanism for a dedicated vehicle, taking into account interoperability with existing transport systems in the vicinity of switches and routes of conventional vehicles, containing the ground, on which the rails are fixed, characterised in that on both sides of the rail system, preferably on the track bed, at least along a fragment of the track used by conventional vehicles there are guiding walls, mounted on movable supporting elements.

2. The mechanism according to claim 1 is characterised in that the guiding walls are mounted on movable support elements in the form of actuators allowing their positioning to be changed, with the actuators affixed to energy-absorbent barriers positioned along at least a fragment of the railway system-track bed, placed on the ground or directly in the ground.

3. The mechanism according to claim 1 is characterised in that the guiding walls are shaped like an angle that embraces the dedicated vehicle on the underside or side or are shared like a plate that embraces the vehicle on its underside or side, while the source of the magnetic field is built into the dedicated vehicle and is positioned so that it corresponds to the position of the guiding walls.

4. The mechanism according to claim 1 is characterised in that in a dedicated vehicle, along at least a fragment of its lateral surfaces, rotary stabilizing elements or sliding bearings cooperating with at least one guiding wall are mounted.

5. The mechanism according to claim 5 characterised in that in the dedicated vehicle, dia- or paramagnetic materials affected by electromagnetic forces are installed along the side and/or underside of the dedicated vehicle.

6. The mechanism according to claim 5 is characterised in that the guiding walls are equipped with diamagnetic or paramagnetic materials, which are affected by electromagnetic forces.

7. The mechanism according to claim 1 characterised in that it is equipped with an emergency system based on a manual method and a pyrotechnic actuator.

8. The mechanism according to claim 1, characterised in that the guiding walls: are mounted on side actuators, slide out from below or slide on integrated guides.

9. The mechanism according to claim 2 characterised in that the actuators are hydraulic or pneumatic or electric.

10. The mechanism according to claim 9 characterised in that the guiding walls in the form of a plate extending from below are mounted parallel to the dedicated vehicle and act as a longitudinal guiding bar along which the dedicated vehicle is directed.

11. The mechanism according to claim 1 characterised in that the guiding walls are permanently mounted on integrated guides placed transversely in the ground in the form of a guide bar, linear guide or rack-and-pinion mechanism, together with the track of a conventional vehicle, preferably equipped with rails or not.

12. The mechanism according to claim 1 characterised in that it is used for any traffic speed and any turning radius of dedicated and conventional vehicles.

13. A method of stabilising the vehicle in the stabilisation and levitation mechanism, characterised in that during the passage of a conventional vehicle the guiding walls are placed in the resting position, and before the passage of a dedicated vehicle by means of the mechanism according to the invention the railway infrastructure is adjusted so that by means of actuators the guiding walls are forced to move closer to the axis of the driving track, i.e. to the main position, and after the passage of the dedicated vehicle the guiding walls are moved back to the resting position by means of actuators allowing conventional vehicles to pass again.

14. The method of claim 13 is characterised in that the driving track of dedicated vehicles is directed by frictional forces which act on rotating stabilizing elements or sliding bearings mounted in the dedicated vehicle.

15. The method of claim 13 is characterised in that the direction of the movement of the dedicated vehicle is set by electromagnetic forces created as a result of magnetic fields from the dedicated vehicle and the guiding walls working with each other.

16. The method of claim 13 is characterised in that the positioning of the mechanism according to the invention in the switch area in order to connect the track for travelling straight or turning, is carried out by means of mechanical stops or electromagnets that set and lock the mechanism in its final position.

17. The method according to claim 13 is characterised in that for the passage of the vehicle, the movement of the guiding walls is blocked in their final positions by means of mechanical stops or electromagnets, located at the extremes of the switch sections and at the extremes of the fixed track, which operate in the last phase of the movement, setting the mechanism in contact with the fixed part of the infrastructure.
